(19) United States
(12) Patent Application Publication
(10) Pub. No.: US 2002/0091968 A1
(43) Pub. Date: Jul. 11, 2002

(54) Object-oriented data driven software GUI automated test harness

(76) Inventors: Donald Moreaux, Meridian, ID (US); Cary Homer, Nampa, ID (US); Steven Stubbs, Boise, ID (US); Kent Johnson, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/757,283

(22) Filed: Jan. 8, 2001

(51) Int. Cl. H04L 1/22

(52) U.S. Cl. 714/38

(57) ABSTRACT

A system for automated testing of an graphical user interface (GUI) of a software application includes creating a test file of a plurality of test steps in a text file format. The test file may be created using any variety of text editor. The test file is used as input to a test harness. In execution, the test harness opens the test file and begins using each line of the test file as a test step. The test harness is configured to execute one of a plurality of automated tests in response to each line of test steps. Each automated test is configured to test a corresponding physical user interface element of the program through a GUI map. The GUI map is configured to define a logical name for each physical user interface element of the software application.

### TECHNICAL FIELD

The invention relates to testing of graphical user interfaces (GUIs) of software applications. More particularly, the invention relates to automating the testing procedures for GUIs of a software applications using an object-oriented data-driven software test harness.

### BACKGROUND ART

A computer program is a series of instructions that direct the operation of a computer. Computer programs are written by computer programmers to achieve a desired purpose. The instructions, taken as a whole, may define a computer application such as a word processing system, an accounting system, an inventory system or an arcade game. Most programs require interaction with the user of the computer program. In the case of a word processing program, the user keys text, formats, and prints documents. In the case of an accounting program, the user enters the desired debits and credits and appropriate documentation, posts and selects reports. The schemes used to prompt the computer user to input data and to output information generated by the computer program to the computer user are known as human/computer interfaces.

Recently, the human/computer interfaces have moved toward graphical user interfaces (GUIs). Instead of using text commands are keystrokes; various functions of a software application are represented by graphical elements such as menus or icons. Moving the cursor to a menu item and clicking on the menu item initiates an action by the software application. As a result, software applications are easier to learn, operate and are aesthetically pleasing.

However, the task of creating GUI interfaces for software application increased the degree of difficulty of software development. In response, computer aided software tools have been created to assist software developers in building, developing, and testing GUIs for application software.

Although computer-aided software tools have increased efficiency for the software developer, ready-made tools designed to test software are limited when testing the GUI of software applications. For instance, many ready-made tools are designed for transactional type of software applications, e.g., transmission of data, creating of a database, entering data into a database, etc. However, these ready-made tools do not readily adapt to the testing of the GUI of software because GUI operations typically consist of cursor movements and actions.

Further, these ready-made tools typically require some advanced training to create test scenarios to test the application software. Typically, these ready-made tools rely on their test language, which may be in the form of scripts, to create scenarios. These test languages typically require training to master the test language and may also be proprietary.

Moreover, many ready-made tools typically are designed to rely on a “capture-replay” paradigm. In this paradigm, the software application or the application under test (“AUT”) typically captures input device events, such as from a mouse or a keyboard, which occur as an operator uses the AUT. The ready-made tool also typically captures the output to a screen as a result of the input device events. This process is known as “recording.”

The captured data is stored until one desires to “replay” the events, such as after the changes to the AUT have been made, during which the monitor output is captured and compared to that which was captured in the earlier recording operation.

The data is typically stored as a series of characters, pixels, etc. This representation is not user-friendly and does not provide any convenient method for modifying the contents. As a result, every time the user application is modified, the operator must recreate the test.

Moreover, with this technique of testing GUIs of software applications, a working version of the AUT must be available. In many cases, this may force the actual testing of the GUI until much later in the development cycle. This may lengthen the development cycle because error detection or debugging occurs over the entire code of the software application.

Some software testers have advocated a move toward “data-driven” or “keyword-driven” testing solutions. In this methodology, a test script is created that contains keywords. As the test script is inputted, keywords within the test script are used to invoke specific functions, thereby testing the GUI of the software application. However, most of the “data-driven” or “keyword-driven” testing solutions are still very much theoretical. Several implementations have been tested, but primarily on the university or small research laboratory level.

### SUMMARY OF THE INVENTION

In accordance with the principles of the present invention, a method for automated testing of an graphical user interface (GUI) of a program includes creating a test file of a plurality of test steps in a text format. The method also includes executing a test harness with the test file as input to the test harness. The test harness is configured to execute one of a plurality of automated tests in response to one of a plurality of test steps. Each automated test is configured to test a corresponding user interface element of the program through a GUI map. The GUI map configured to define a logical name for each user interface element of the program.

One aspect of the present invention provides for a system for automated testing of a graphical user interface (GUI) of an application. The system includes at least one processor, a memory coupled to the at least one processor and a test harness. The test harness resides in the memory and executed by at least one processor, wherein the test harness is configured to execute one of a plurality of automated tests in response to one of a plurality of test steps of a data file. Each automated test configured to test a corresponding user interface element of the application through a GUI map. The GUI map configured to define a logical name for each user interface element of the application.

Another aspect of the present invention provides for a computer readable storage medium, on which is embedded one or more computer programs; the one or more computer programs further comprising a set of instructions creating a test file of a plurality of test steps in a text format. The computer program further includes a set of instructions for executing a test harness with the test file as input to the test harness. The test harness configured to execute one of a plurality of automated tests in response to one of a plurality of test steps. Each automated test configured to test a corresponding user interface element of the program through a GUI map. The GUI map configured to define a logical name for each user interface element of the program.

In comparison to known prior art, certain embodiments of the invention are capable of achieving certain advantages, including some or all of the following: (1) scenarios being tested by the test harness may be created by a text files, thereby eliminating the need for a proprietary test language and without using “capture” techniques; (2) the tests tools may become independent of the AUT and the operating system; (3) the test harness may be utilized with many versions of various AUTs; (4) test scenarios may be written while the program is being developed; and (5) limiting the effort required to maintain the automated tests.

Additional advantages and novel features of the invention will be set forth in part in the description which follows and in part will become apparent to those skilled in the art upon examination of the following or may be learned by practice of the invention. The advantages of the present invention may be realized and attained by means of instrumentalities and combinations particularly pointed in the appended claims.

### DESCRIPTION OF DRAWINGS

Features and advantages of the present invention will become apparent to those skilled in the art from the following description with reference to the drawings, in which:

FIG. 1 is an illustration of a computing environment that may implement an embodiment of the present invention;

FIG. 2 illustrates a block diagram of a computing platform that may implement the test automation harness;

FIG. 3 illustrates a block diagram of an embodiment of a test automation harness;

FIG. 4a illustrates a more detailed block diagram of the test harness 320 illustrated in FIG. 3;

FIG. 4b illustrates an exemplary flow diagram of creating the GUI map of FIG. 4a.

FIG. 5 illustrates a flow diagram of testing an AUT utilizing the test automation harness of FIG. 3;

FIG. 6 shows a more detailed block diagram of the architecture of the test harness shown in FIG. 3; and

FIG. 7 is block diagram of the various syntaxes used by external files of the test automation harness shown in FIG. 3.

### DETAILED DESCRIPTION OF PREFERRED EMBODIMENTS

For simplicity and illustrative purposes, the principles of the present invention are described by referring mainly to an exemplary embodiment thereof. Although the preferred embodiment of the invention may be practiced as a software system, one of ordinary skill in the art would readily recognize that the same principles are equally applicable to, and can be implemented in, a hardware system, and that any such variation would be within such modifications that do not depart from the true spirit and scope of the present invention.

In accordance with the principles of the present invention, a system, a test automation harness, for automated testing of a graphical user interface (GUI) of a software application includes creating a test file with a plurality of test steps in a text format. The test file may be created using any type of ASCII test editor. The test file is used as input to sequence a test harness within the test automation harness. In execution, the test harness parses the test file and begins using each line of the test file as a step in the testing of the AUT. The test harness is configured to execute one of a plurality of automated tests in response to each line of test steps. Each automated test is configured to test a corresponding physical user interface element of the program through a GUI map. The GUI map is configured to define a logical name for each user interface element of the software application.

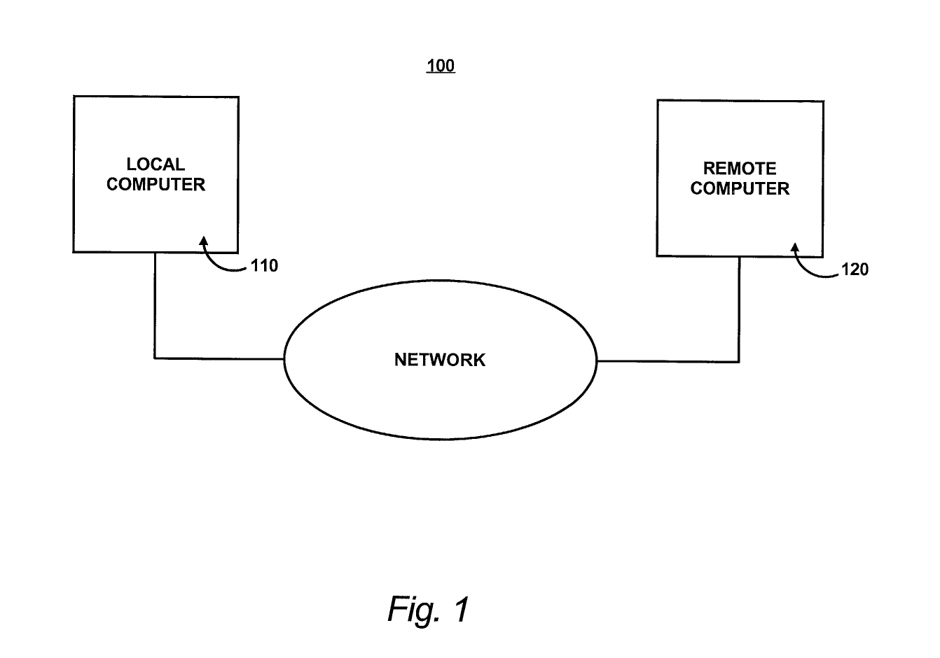

FIG. 1 is an illustration of a computing environment that may implement an embodiment of the present invention. As shown in FIG. 1, a network system 100 that includes at least a local computer 110 interconnected with a remote computer 120 via a data processing network 130.

The local computer 110 and/or remote computer 120 may be configured to provide a computing platform in order to implements a software test automation harness. The test automation harness may be executed on either one of the local computer 110 and the remote computer 120, and the software application may be tested on the other of the local computer 110 and the remote computer 120. Alternatively, any combination networked computing platforms may be used to implement the test automation harness.

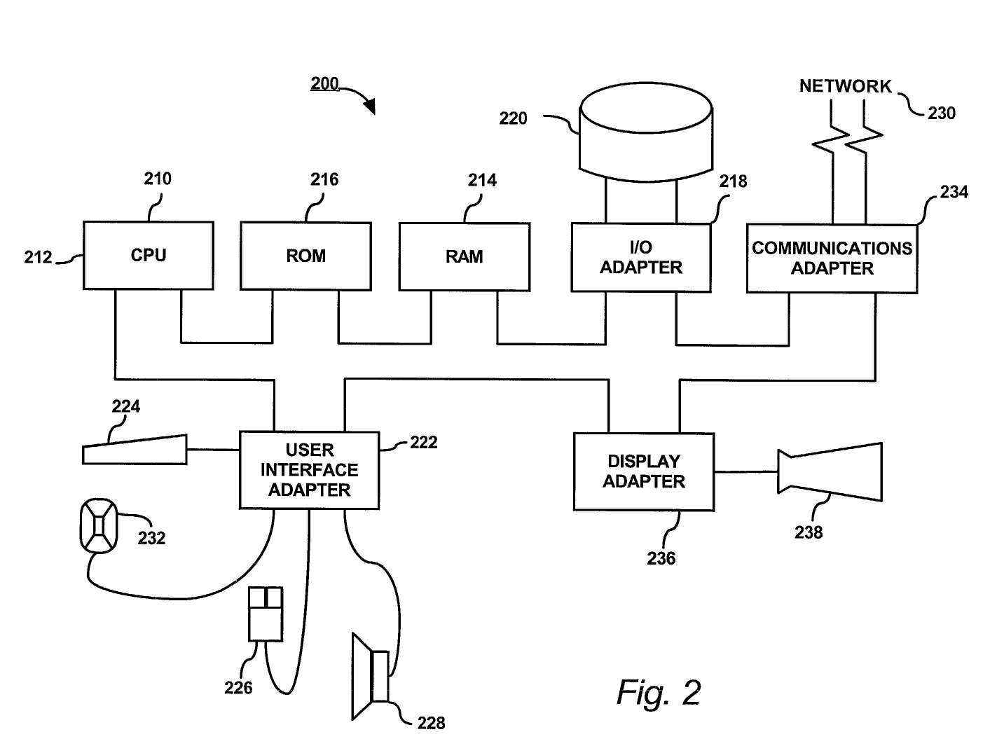

The local computer 110 or the remote computer 120 may be a personal computer, a workstation, or a mainframe computer. A representative hardware environment 200 of either computer is depicted in FIG. 2, which illustrates a suitable hardware configuration that may implement the test automation harness. The representative hardware environment 200 may have a central processing unit 210, e.g., as a conventional microprocessor, and a number of other units interconnected via a system bus 212. The representative hardware environment 200 shown in FIG. 2 includes a Random Access Memory 214 (RAM), a Read Only Memory 216 (ROM), an I/O adapter 218 for connecting peripheral devices such as disk units to the bus 212, a user interface adapter 222 for connecting a keyboard 224, a mouse 226, a speaker 228, a microphone 222, and/or other user interface devices such as a touch screen device (not shown) to the bus 212. The representative hardware environment 200 may also have a communications adapter 234 for connecting the representative hardware environment 200 to the processing network 130 and a display adapter 236 for connecting the bus 212 to a display device 238.

The data processing network 130 may be configured to provide a communication path between the local computer 110 and the remote computer 120. The data processing network may be a local area network, wide area network, the Internet, etc.

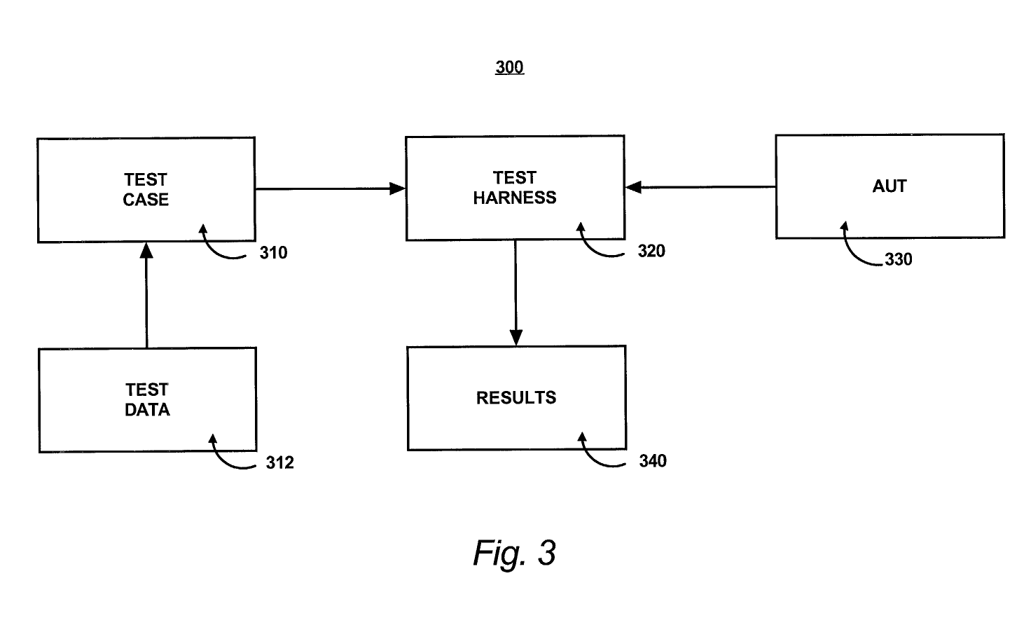

FIG. 3 illustrates a block diagram of an embodiment of a test automation harness 300. The test automation harness 300 is a system for automated testing of a GUI of a software application. As shown in FIG. 3, the test automation harness 300 includes a test case file 310, a test harness module 320, an application under test (AUT) 330, and a results module 340.

The test case file 310 may be configured as a text file, preferably as an ASCII text format. The test case file 310 may be created with simple text editors or word processing programs, provided extraneous formatting is removed from all lines of the test case file 310. Moreover, the test case file 310 may be further configured to format test data input in a tab delimited file format with each line of the test data file 310 representing a step of the testing of the AUT 330. A test data file 312 may accompany the test case file 310 in instances where there are advantages in isolating logical names of graphical user elements of the AUT. The test data file 312 may be also configured in a tab delimited ASCII file format.

The test harness module 320 may be configured to sequence the actions of the test automation harness 300 to drive the test scenarios that test the elements off the GUI of the AUT 330. For example, the test harness module 330 may call and execute necessary functions in response to a line of input test data from the test case file 310 to test the AUT 330.

The AUT 330 may be a software application that is being tested by the test automation harness 300. The AUT 330 may be located on a remote computing platform or within the same computer platform as the test automation harness 300. The test automation harness 300 is a system for automated testing of a GUI of a software application.

The results module 340 may be configured to hold the results for the sequences of actions executed by the test harness 320. The output data may be in the form of pass/fail determinations, error conditions, number of tests aborted, etc. Other types of data may be collected depending on the nature of software application being tested and the preferences of the tester. The output data may be in the form of an output data file. The output data file 340 may be located on a remote computer platform or within the same computer platform as the test automation harness 300.

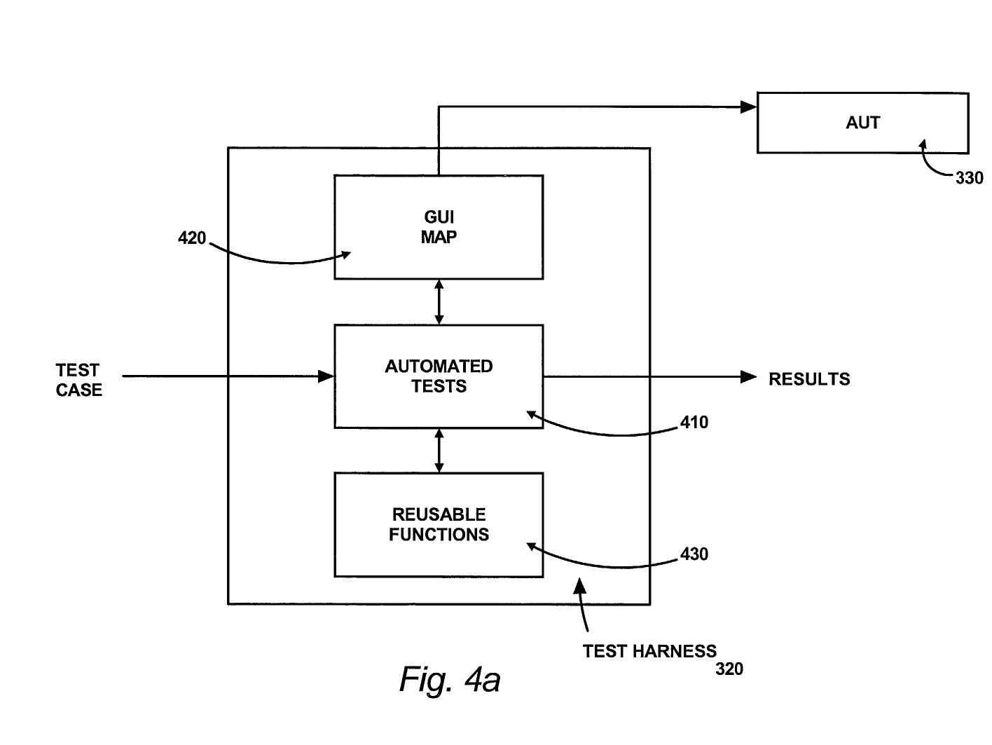

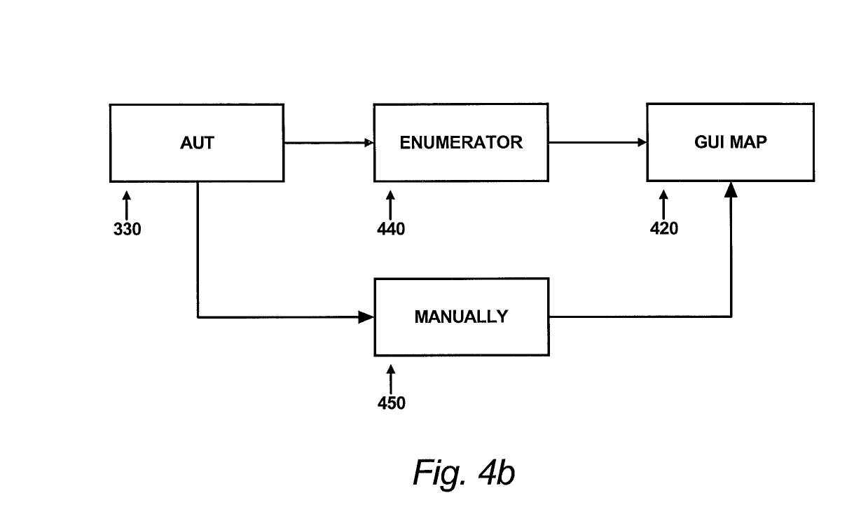

FIG. 4 is a more detailed block diagram of the test harness 320 illustrated in FIG. 3. As shown in FIG. 4, the test harness 320 includes an automated test module 410, a graphical user interface (GUI) map 420, and a reusable function module 430.

The automated test module 410 may be configured as a test engine that sequences the actions necessary to the test the AUT 330 from the test case file 310. In response to a line of test input from the test case file 310, the automated test module 410 executes an associated automated test of a library of automated tests located within the test harness 300. As the selected automated test is executing, the selected automated test calls and executes reusable functions associated with the selected automated test from the reusable function module 430 to test a given corresponding physical graphical user element.

The reusable function module 430 may be configured to interface with the automated test module 410 to provide a library of reusable functions for the test automation harness 300. The reusable functions in the reusable function module 430 may be further configured to encapsulate the functions that are common to all testing, e.g., opening and closing applications, writing to text boxes or other user interfaces components, etc. A library of automated test scripts, which are contained in a test tool library as well as a custom library, also uses the reusable functions repeatedly. The logic to process inputs and outputs, and respond to application results are further embedded in the reusable functions of reusable function module 430.

The GUI map 420 may be configured to provide mapping of a logical name for each physical user interface element of the AUT 330, thereby removing any literal references to the AUT 330 within the automated test module 410. This enables a test designer to make the automated tests within the automated test module 410 easier to maintain because changes in the AUT 330 do not require changes to the tests, only to the mapping.

FIG. 4b illustrates an exemplary flow diagram of creating the GUI map of FIG. 4A. As shown in FIG. 4b, the GUI map 420 may be created manually 450 by a test designer by examining design documents, prototypes, specifications, actual code, etc. Alternatively, an enumerator tool, 440 may be utilized to generate the GUI map 420 from the actual software code of the AUT 330. The enumerator tool, or GUI analyzer, 440 may be configured to extract from the code of the AUT 330 information necessary to create the GUI map 420, such as logical name, identification values, class, ordinals, physical names, etc.

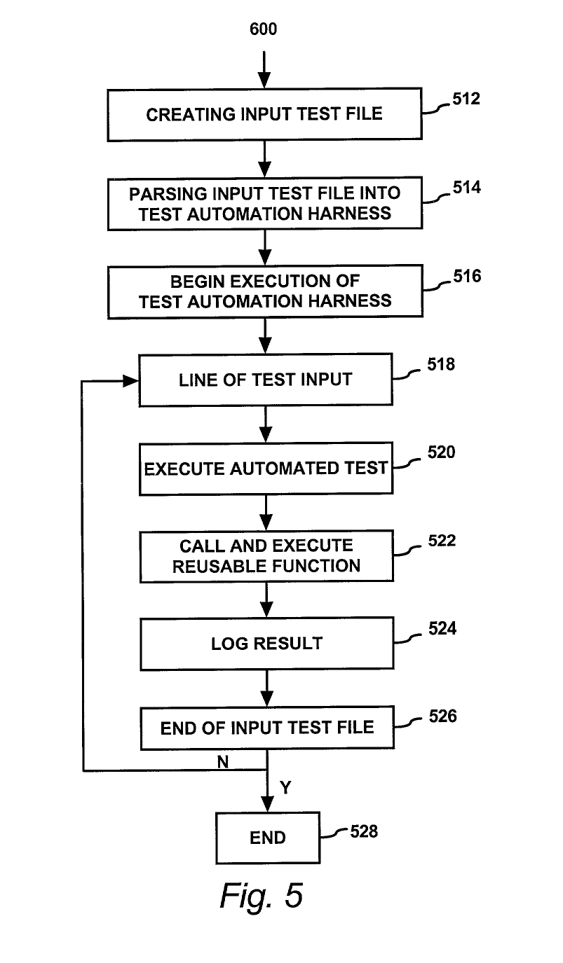

FIG. 5 illustrates a flow diagram 500 of testing an AUT utilizing the test automation harness 300. A user would create an input test case file 310 utilizing a simple text editor, in step 512. After creating the input test case file 310, the user, in step 514, would link the input test case to the test harness 320. In step 516, the user would initiate the execution of the test harness 320. The test harness 320, in step 518, would read a line of input from the input test case file 310. In response to the line of input, the specified automated test would execute in the automated test module 410, in step 520. The specified automated test would call and execute select reusable functions from the reusable functions module 430 associated with the specified automated test, in step 530. After the specified automated test has finished, the test harness 320 logs the results of the specified automated test into the results module 340, in step 524. The test harness 320, in step 526, checks whether the test case file 310 contains any additional steps. If so, the test harness 320 returns to step 518. Otherwise, the test harness 320 stops executing.

The above description describes the general software architecture of the test automation harness 300 and its operation to enable someone of ordinary skill in the art to practice the invention. The following description is an exemplary embodiment of a detailed software architecture of the test automation harness 300.

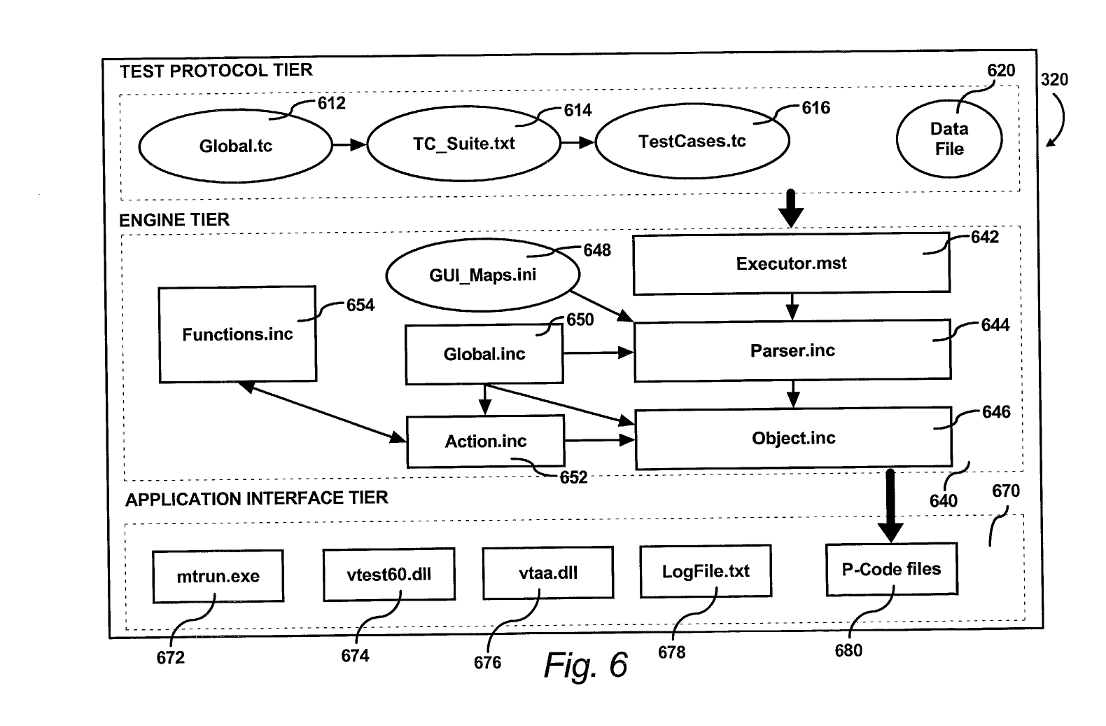

FIG. 6 shows a more detailed block diagram of the architecture 600 of the test harness 320 shown in FIG. 3. The architecture of the test harness 320 may be described in a three level model: a test protocol tier 610, an engine tier 640 and an application interface tier 670.

The test protocol tier 610 may be considered the area with which a test designer would primarily interface. Typically, the files that the test designer would utilize are in ASCII format and are external to the actual test code. These files include at least a test case file 310, a test data file 312, a GUI map file 420, and a test suite file 740, as shown in FIG. 6.

The test case file 310 may be configured as a representation of one complete test for the AUT 330 including all of the steps needed to open and close the AUT 330. The test case file 310 may contain an “English-like” description of each step within a test case scenario. The test case file 310 may contain multiple files, each file representing any number of steps representing a given test case.

The test case file 310 may also be configured to dictate the order in which the engine tier 640 executes a test sequence by the order of the steps. The test case file 310 may have three different types of steps, which are characterized by the specific actions they perform: (1) standard steps; (2) navigation steps; and (3) management steps. The standard steps may be steps that execute with data to enter, delete or compare as in placing a string in a combination box, removing a file folder from a treelist, or comparing a string with a drop-down box selection. The navigation steps may be steps that change the AUT state, e.g., moving from one screen to the next, selecting a tab, or starting and stopping an application. These steps may be considered a subset of the standard steps. The management steps may be steps that control how the test data will be managed, e.g., steps that advances a row pointer to a next row when a next row of test data values is needed for a next step.

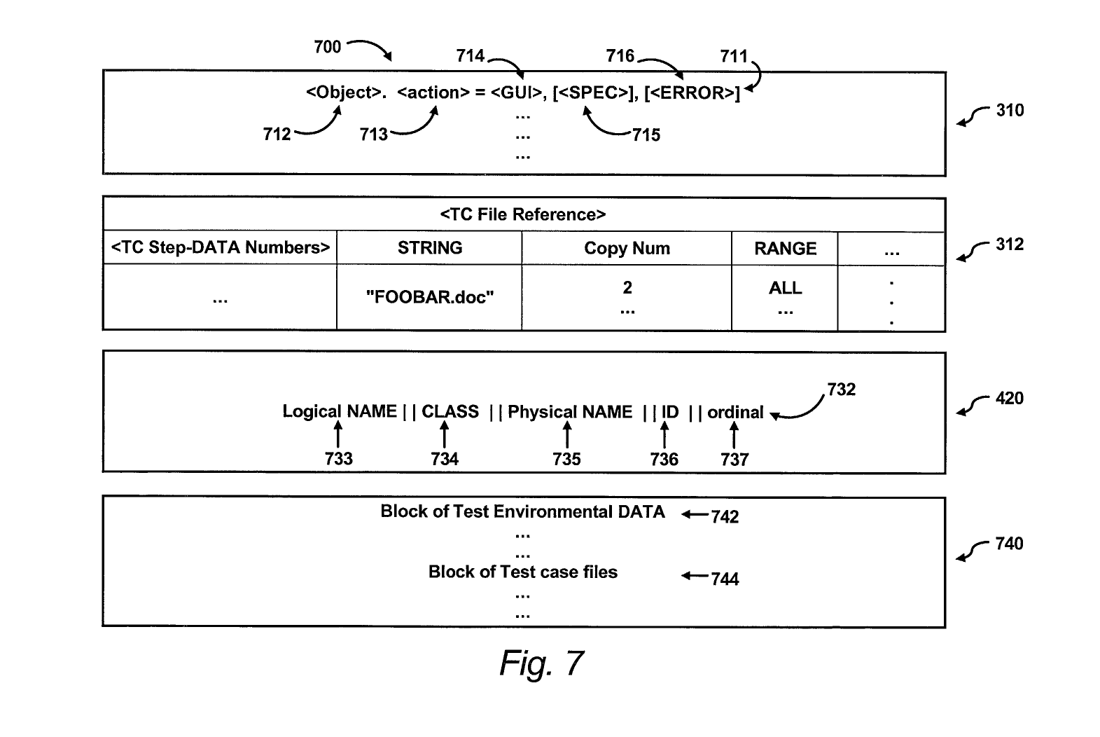

However, the different steps of a test case file 310 may have similar syntax as illustrated in FIG. 7. As shown in FIG. 7, the syntax 711 includes an object field, an action field, a GUI field, a specification field and an error field. The object field 712 may represent a required field value that names a software component or test element that is involved in the test step such as “Button”, “File”, “Tab”, “Data”, etc. The action field 713 may represent a required field value that enumerates an action taken against an application under test such as “Push”, “Print”, “Select”, “Next”, etc. The GUI field 714 may represent an identification reference for a window or window component involved in the test step. This value may be represented in three ways: a literal value, e.g., “@4” for ordinal reference, a physical name, e.g., “@windowID” or a logical name, e.g., “JetSuite Pro”. The GUI field may not be a required value for the management step. The specification field 714 may represent an optional field that may be a literal value as in supplying a string to be used to enter text, or a reference to a column within the test data file 310. In the latter case, an “&” character should proceed the name of the test case file column. In the former case, the value should be placed within quotes, e.g., “hello world”.

The error field 715 of the test case file 310 may represent an optional field that sets an error recovery level for this test step. If no value is specified in the test step, a default value is assumed. There may be five error recovery values, listed from least severe to most: ERR_IGNORE, ERR_STEP, ERR_STEP_N, ERR_FAIL, and ERR_STOP. The ERR_IGNORE value may represent that the current step may be skipped without resetting the test automation harness 300 and does not log an error message and continues to the next step in the file. The ERR_STEP value may represent a value similar to ERR_IGNORE except that the error message is recorded in a log file. The ERR_STEP_N value may represent the number of test case steps to jump before reaching the next step to be executed in the current test case file, where N may be a value between 1 to 999. If this error option is set, closing all instances of the AUT resets the test automation harness 300. Subsequently, the next test case file in a test suite is then executed. The ERR_STOP value may represent that the step log an error message and fail the entire test suite and suspend all further testing.

The test data file 312 may be configured to contain literal values for logical names to be used by the steps of the test case files 312. The test data file 312 may in an ASCII, a tab delimited file format. The test data file 312 may also be configured such that each line, or record, of values is to be used once and only once. Further, data for each test step is given on line with a column reference for each logical name. In the event that a file in the test case file 310 attempts to read data past the last record in the test data file, the step executes using the last line of data used by the previous step. In response, an error message is logged indicated that this event had occurred.

The test data file 312 may be further configured to have a field value that represents the name of a file in the test case file 310 that will use the data of this test data file. The next record in the file contains the text identifier for each column of data.

The GUI map file 420, as discussed above, may be configured to provide mapping of a logical name for each physical user interface element of an AUT. The creation of the GUI map file 420 may the responsibility of a test automation engineer and/or a test designer. In the early stages of development of the AUT, prototypes, design documents, etc., are utilized to determine the logical names for each of the physical user elements of the AUT. Later, as code is written, tools such as a enumerator or probe tool are used to extract the remaining information such as ID, class, ordinals, etc., which is configured to extract the same from the code of the AUT. The GUI map file 420 may be a line-by-line collection of data, with double pipe “∥” characters used to delimit the data elements.

The GUI map file 420 may be configured to have a syntax 732 of a logical name 733, a class 734, a physical name 735, an ID value 736 and an ordinal value 737. The logical name 733 is the name of the AUT end-user would see associated with a given graphical user element or component. The class 734 is the name of object-oriented class that the graphical user element belongs. The physical name 735 is the name that the software developer used to label the given graphical user element. The ID value 736 is the unique numeric value assigned to the given graphical user element. The ordinal value 737 is a numeric value that is assigned to the given graphical user element, which is unique to its class of objects.

The test suite file 740 may be configured to contain two blocks of information: (1) a collection of required and optional test environment variables; and (2) a list of the test case files to1 be run during a test session.

The block of required test environment variables includes at least a DELAY TIME variable, a STEP_TRIES variable, a TEST_DATA variable, a GUI_MAP variable, and a CAPTURE variable. The DELAY_TIME variable may represent a time value, in clock seconds that will be interposed between the actual executions of the test steps. A default value of zero is assumed but can be varied in order to view execution or to address any synchronization problems. The STEP_TRIES variable may represent a numeric value used by the test engine functions that indicates the number of times a step should be executed when a step execution failure occurs. A default value of one is assumed and means that the step will execute once prior to logging the failure of the step. The TEST_DATA variable may represent a path string that indicates the location of the test data file on the test client or computing platform. No default value is assumed and a missing value causes the test automation harness to suspend testing. The GUI_MAP variable may represent a path string that indicates the location of the GUI map file on the test client or computing platform. No default value is assumed and a missing value causes the test automation harness 300 to suspend testing. The CAPTURE variable may represent a screen capture flag indicating a test wide capture of active windows each time an error occurs. A default value of zero (turned off) is assumed unless the test designer specifically enables screen capture, e.g., screen.capture.

The other block of test environment variables includes variables that may be used to avoid repetition of certain strings, which should be applicable only to the files in the test case files 710.

The list of test case files is a listing and the complete path location of the test case files to be executed during a given testing session.

Returning to FIG. 6, the test protocol tier 610 includes a global.tc module 612, a test_case_suite.txt module 614, a test_case.tc module 616 and the test data file 620.

The global.tc module 612 may be configured to provide a single location for commonly used parameters and their values. The global.tc module 612 may be an ASCII file that interfaces with test_case_suite.txt module 614, where the test_case_suite.txt module 614 references the global.tc module 612 before referencing any other existing test case modules. The global.tc module 612 is further configured to be verified by an executor.mst module 642 prior to execution of the test harness and to have the values of the global.tc module 612 to be read by a parser.inc module 644.

The executor.mst module 642 of the engine tier 640 may be configured to log a failure in the test execution of the test under two conditions: (1) if global.tc module 612 is referenced in the test_case suite.txt module 614 and does not exist; or (2) if global.tc module 612 does not exist and is not referenced in the test_case_suite.txt module 614 and at least one test_case.tc module 616 contains a reference to a global variable in place of an actual value.

The test_case_suite.txt module 614 may provide a mechanism for a test designer to collect and order the individual test cases. The test_case_suite.txt module 614 may be configured to act as a test suite and a test manager, containing a list of files in the test_case.tc module 616 to be run. The test case suite.txt module 614 may further be configured to specify the order in which the selected files are to be run for a particular session.

The test case.tc module 616 may be configured to provide an identification of an object, GUI component or software element, and an action taken on the object, along with “user-level” properties and values for those properties associated with an object-action pair. The test case.tc module 616, thus, provides a mechanism through which a test designer writes test case descriptions. The test case.tc module 616 may further be configured to interface with the test_case_suite.txt module 614, which lists selected files of the test_case.tc module 616 that will be executed for a given test suite. The executor.mst module 642 may also be configured to locate and open the selected files in response to an execution of the given test suite. In the event of errors in the test_case.tc module 616, the parser.inc module 644 skips a file that contains an error in the test_case.tc module 616.

The engine tier 640 includes the components executor.mst module 642, the parser.inc module 644, an object.inc module 646, a GUI_Map.inc module 648, a global.inc module 650, an action.inc module 652, and a functions.inc module 654.

The executor.mst module 642, as described above, may also be configured to prepare the test automation harness 300 for a test event to execute and to open the test_case_suite.txt module 614. Subsequently the executor.mst module 642 may read the contents of that file line by line, thereby providing a test sequencer and high-level error handler. The executor.mst module 642 may further be configured to interface with the parser.inc module 644.

The parser.inc module 644, as described above, may also be configured to read and parse files, on a line-by-line basis, sent to it by the executor.mst module 642. The parser.inc module 642 may store names and values to be used. Object and action names are tokenized and any properties and associated values for that object/action pair are passed to a function in the object.inc module 652 until a terminating character, such as the right curly bracket character, “}“is encountered in response to reading a line from a test_case.tc module 616 file.

The object.inc module 646 may be configured to locate the appropriate GUI_Map.ini module 648 based upon the value of an object variable, thereby isolating the functionality for interacting with the GUI map. Further, the object.inc module 646 may further be configured to log an error in response to not finding the appropriate GUI_Map.ini module 648 file.

The object.inc module 646 may further be configured to interface with the global.inc module 650 to retrieve index values for a property array and to call functions within the action.inc module 652 sending along the name of the GUI Map file, the action to execute, the property names, and the values.

The GUI_Maps.ini module 648 may be configured to provide a location outside of the code of the test automation harness 300 that allows test designers to define logical names for the physical user interface elements. User interfaces changes in the application under test then do no require changes in the test themselves, only to the mapping.

The GUI_Maps.ini module 648 may further be configured to have a syntax that includes a typical “.ini” file structure where the name of each map file relates to an object value, a key word value in the map file is related to the action value, and property names (physical user interface element) under each key word are assigned values (logical names).

The actions.inc module 652 may be configured to provide a single location for functions that are used to select functions from the reusable function library located in the reusable function module 430. The actions.inc module 652 may be further configured to use as input the values for an object, action and property array. From these inputs, the appropriate action functions are called, and the input data is passed with the call to the selected functions.

The actions.inc module 652 may be further configured to interface with the object.inc module 646, which calls the action.inc module 652 with the values for action, object, and property names and values. Further, the actions.inc module 652 may call the functions.inc module 654, sending values for action, object, property names and values, and data from the selected files of the GUI_Map.ini module 648.

The functions.inc module 654 may be configured to provide isolation for a set of functions that execute a single task into one module. The functions.inc module 652 may be a collection of files or modules that comprise the function library. Each “.ini” file gets its name on the basis of the component it is meant to test. For example, “DISK.INI” has to do with disk I/O, such as name file, save as, save, print, and other actions that can be take against the selected component. Moreover, these functions may also contain calls to error and event handling routines.

The application interface tier 670 includes an mtrun.exe module 672, a vtest60.dll module 674, a vtaa.dll module 676, a logfile.txt module 678 and a p-code module 680. The mtrun.exe module 672, the test60.dll module 674 and the vtaa.dll module 676 are part of a commercial development environment's tool library.

The mtrun.exe module 672, the vtest60.dll module 674, and the vtaa.dll module 676 are execution files used when the test automation harness 300 executes. The logfile.txt module 678 may be configured to receive the output test data, which may include results, errors, etc. The p-code module 680 may contain the pseudo code from the all of the components of the test automation harness 300, which is used by the mtrun.exe module 672 to execute on the computing platform.

Although the preferred embodiment of the invention utilizes Test Basic language to practice the invention, any one of ordinary skill in the art would recognize that the invention may be practice with other programming languages such as C/C++, Java, etc., without departing from the true spirit and scope of the invention.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only

What is claimed is:

1. A method for automated testing of a graphical user interface (GUI) of a program, said method comprising:
creating a test file comprising a plurality of test steps in a text format; and
executing a test harness with said test file as input to said test harness, said test harness configured to execute one of a plurality of automated tests in response to one of a plurality of test steps, each automated test configured to test a corresponding user interface element of said program through a GUI map, said GUI map configured to define a logical name for each user interface element of said program.

2. The method for automated testing of a GUI of a program according to claim 1, wherein each test step comprises an object, an action, and an identification reference.

3. The method for automated testing of a GUI of a program according to claim 2, wherein each test step further comprises an optional field value.

4. The method for automated testing of a GUI of a program according to claim 3, wherein each test step further comprises an error recovery value.

5. The method for automated testing of a GUI of a program according to claim 1, further comprising:
generating said GUI map of said program by extracting a logical name, a physical name, an identification, and an ordinal value for each user interface element of said program.

6. The method for automated testing of a GUI of a program according to claim 1, further comprising:
generating said GUI map of said program from one of a prototype of said program, a design document of said program and an earlier version of said program.

7. The method for automated testing of a GUI of a program according to claim 1, wherein:
each automated test is further configured to retrieve and to execute at least one of a plurality of associated reusable functions in response to said one of said plurality of test steps.

8. The method for automated testing of a GUI of a program according to claim 1, further comprising:
outputting results of the execution of said plurality of automated tests in response to said test file.

9. A system for automated testing of a graphical user interface (GUI) of an application, said system comprising:
at least one processor;
a memory coupled to said at least one processor;
a test harness residing in said memory and executed by said at least one processor, wherein said test harness is configured to execute one of a plurality of automated tests in response to one of a plurality of test steps of a data file, each automated test configured to test a corresponding user interface element of said application through a GUI map, said GUI map configured to define a logical name for each user interface element of said application.

10. The system for automated testing of a GUI of an application according to claim 9, wherein each test step comprises an object, an action, and an identification reference.

11. The system for automated testing of a GUI of an application according to claim 10, wherein each test step further comprises an optional field value.

12. The system for automated testing of a GUI of an application according to claim 11, wherein each test step further comprises an error recovery value.

13. The system for automated testing of a GUI of an application according to claim 9, wherein said GUI map of said application is generated with a GUI analyzer configured to extract a logical name, a physical name, an identification and an ordinal value for each user interface element of said application.

14. The system for automated testing of a GUI of an application according to claim 9, wherein said GUI map of said application is generated from one of a prototype of said application, a design document of said application, and an earlier version of said application.

15. The system for automated testing of a GUI of an application according to claim 9, wherein each automated test is further configured to retrieve and to execute at least one of a plurality of associated reusable functions in response to said one of said plurality of test steps.

16. The system for automated testing of a GUI of an application according to claim 9, wherein said test harness is further configured to generate an output file configured to contain results of said execution of said plurality of automated tests in response to said test file.

17. A computer readable storage medium on which is embedded one or more computer programs, said one or more computer programs implementing a method for automated testing of a graphical user interface (GUI) of an application, said one or more computer programs comprising a set of instructions for:
creating a test file a plurality of test steps in a text format; and
executing a test harness with said test file as input to said test harness, said test harness configured to execute one of a plurality of automated tests in response to one of a plurality of test steps, each automated test configured to test a corresponding user interface element of said program through a GUI map, said GUI map configured to define a logical name for each user interface element of said program.

18. The computer readable storage medium in according to claim 17, said one or more computer programs further comprising a set of instructions for:
generating said GUI map of said program by extracting a logical name, a physical name, an identification, and an ordinal value for each physical element of said program.

19. The computer readable storage medium in according to claim 17, said one or more computer programs further comprising a set of instructions for: outputting an output file configured to contain results of the execution of said plurality of automated tests in response to said test file.

20. The computer readable storage medium in according to claim 17, wherein said one or more computer programs further comprising a set of instructions for:
each automated test further configured to retrieve and to execute at least one of a plurality of associated reusable functions in response to said one of said plurality of test steps.
